(19) United States
(12) Patent Application Publication
(10) Pub. No.: US 2017/0180782 A1
(43) Pub. Date: Jun. 22, 2017

(54) Method and electronic device for displaying chat messages in live broadcasting application

(71) Applicants: Le Holdings (Beijing) Co., Ltd., Beijing (CN); LE SHI INTERNET INFORMATION&TECHNOLOGY CORP., BEIJING, Beijing (CN)

(72) Inventor: Ruike LI, Beijing (CN)

(21) Appl. No.: 15/241,778

(22) Filed: Aug. 19, 2016

Related U.S. Application Data
(63) Continuation of application No. PCT/CN2016/088695, filed on Jul. 5, 2016.

(30) Foreign Application Priority Data
Dec. 21, 2015 (CN) 201510964529X

(51) Int. Cl. H04N 21/431; H04N 21/4788; H04N 21/81; H04L 12/58

(52) U.S. Cl. CPC H04N 21/4316; H04L 51/046; H04N 21/4788; H04N 21/4318; H04N 21/8126

(57) ABSTRACT

Disclosed are a method and device for displaying chat messages in a live broadcasting application. A local region of an interface of the said live broadcasting application is pre-set to have a sliding layout area for displaying a chat message, comprises: receiving chat messages via a message receiving ingress provided by the said live broadcasting application; and displaying each of the received chat messages in the said sliding layout area in sequence according to the order of receipt of the chat messages.

### CROSS REFERENCE TO RELATED APPLICATIONS

The present disclosure is a continuation of PCT application which has an application number of PCT/CN2016/088695 and was filed on Jul. 5, 2016. This application is based upon and claims priority to Chinese Patent Application NO.201510964529.X, titled “method and device for displaying chat messages in live broadcasting application”, filed on Dec. 21, 2015 with the State Intellectual Property Office of People's Republic of China, the entire contents of both of which are incorporated herein by reference.

### TECHNICAL FIELD

The disclosure relates to the technical field of network communication, and in particular to a method and device for displaying a chat message in a live broadcasting application.

### BACKGROUND

In a live broadcasting application, in order to improve entertainment and interaction, an audience and a broadcaster need to communicate with each other. In a general case, a user may make comments on live broadcasting content by transmitting a chat message, thereby sharing them with other users.

Nowadays, when chat messages transmitted by various users are to be displayed in the live broadcasting application, generally the chat messages are directly covered on a live broadcasting picture. In addition, respective messages stay on a screen for the same time period; when a message stays on the screen for a preset time threshold (for example 3 seconds), the message progressively fades out and disappears from the screen.

In the above solution, in a case that there are too many chat messages in a period of time, the chat messages will occupy a whole live broadcast screen, and each message disappears after a preset time threshold, which results in that the live broadcasting picture may be completely covered by chat messages within a particular period of time, thereby affecting users' normal watching of the live broadcasting content, which may result in missing part of the program.

### SUMMARY

According to an aspect of one embodiment of the disclosure, a method used in a live broadcasting application for displaying a chat message is provided, where a local region of an interface of the live broadcasting application is pre-set to have a sliding layout for displaying a chat message, and the method includes:

receiving chat messages via a message receiving ingress provided by the said live broadcasting application; and

displaying the received chat messages sequentially in the sliding layout area in sequence according to the order of receipt of the chat messages.

According to another aspect of embodiments of the present invention, it provides a non-transitory computer-readable storage medium, wherein the said non-transitory computer-readable storage medium stores executable instructions, the said computer can execute the instructions to execute any one of the above mentioned methods used in a live broadcasting application for displaying a chat message prescribed by the present disclosure.

According to another aspect of embodiments of the disclosure, an electronic device is further provided, which includes: at least one processor; and a memory communicably connected with the said at least one processor; wherein the said memory stores instructions executable by the said at least one processor, wherein the said instructions are used to execute any one of the prescribed, by the present application, methods used in a live broadcasting application for displaying a chat message.

The above description is only the outline of the technical solutions of the disclosure. In order to make the technical means of the disclosure to be more clearly understood, the disclosure may be implemented according to contents of the specification. In order to make the above and other objects, features and advantages of the disclosure become more obviously and easier to be understood, embodiments of the disclosure are provided hereinafter.

### BRIEF DESCRIPTION OF THE DRAWINGS

One or more embodiments of the present invention are to be further elaborated in detail with reference to the accompanying figures. It should be noted that, unless specifically stated otherwise, components and procedures of corresponding arrangements, numerical expressions and values disclosed do not limit the scope of the present invention. The drawings are not to scale, unless being specified otherwise.

FIG. 1 is a flow chart of a method used in a live broadcasting application for displaying a chat message in accordance with an embodiment of the disclosure;

FIG. 2 is a flow chart of a method used in a live broadcasting application for displaying a chat message in accordance with an embodiment of the disclosure;

FIG. 3a illustrates a schematic diagram in which one message is displayed in a sliding layout area;

FIG. 3b illustrates a schematic diagram in which two messages are displayed in a sliding layout area;

FIG. 3c illustrates a schematic diagram in which three messages are displayed in a sliding layout area;

FIG. 3d illustrates a schematic diagram in which multiple messages are displayed in a sliding layout area;

FIG. 4 illustrates a structural diagram of a device for displaying a chat message in a live broadcasting application in accordance with an embodiment of the disclosure; and

FIG. 5 illustrates a hardware structure of a device executing a method used in a live broadcasting application for displaying a chat message, according to an embodiment of the present disclosure.

### DETAILED DESCRIPTION

Hereinafter exemplary embodiments of the disclosure are described in detail with reference to the drawings. Although the drawings show the exemplary embodiments of the disclosure, it should be understood that the disclosure may be implemented in various forms and is not limited by the embodiments prescribed here. In contrast, the embodiments are provided such that the disclosure can be understood more thoroughly and the scope of the disclosure can be completely conveyed to those skilled in the art.

According to embodiments of the disclosure, a method and device for displaying a chat message in a live broadcasting application are provided, which can at least solve the problem of the conventional display in which chat messages often easily occupy the entire screen affecting users' normal watching of live broadcasting pictures.

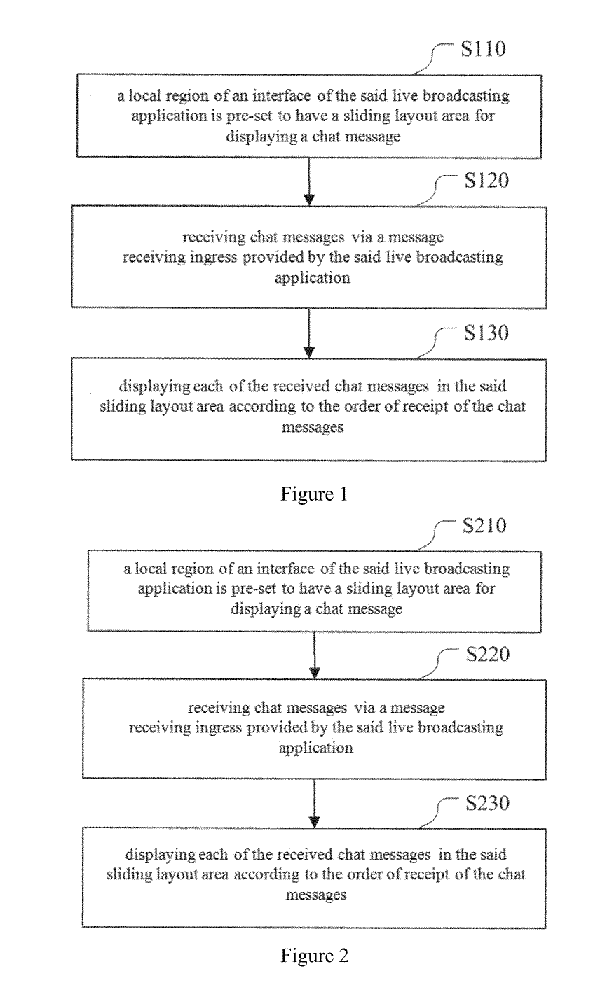

FIG. 1 illustrates a flow chart of a method used in a live broadcasting application for displaying a chat message in accordance with an embodiment of the disclosure. As shown in FIG. 1, such method includes the following steps.

In step S110, a local region of an interface of a live broadcasting application is pre-set to be a sliding layout area for displaying chat messages.

The sliding layout area can be located at bottom of the live broadcasting application interface, or be located at top of the live broadcasting application interface, or be located at one side of the live broadcasting application interface. Those skilled in the art may flexibly pick a location and size of the sliding layout area as needed, such that main contents to be displayed on a screen will not be covered to the greatest extent, and chat messages can also be clearly shown on the screen in full.

In step S120, chat messages are received via a message receiving ingress provided by the live broadcasting application.

The message receiving ingress provided by the live broadcasting application may be realized by a word input box, a voice input button and so on. For the purpose of displaying words conveniently, the maximum number of words of each chat message can be configured in advance, or else a chat message of many words can be automatically broken into some separate chat messages.

In step S130, the received chat messages are displayed in the sliding layout area in sequence according to the order of receipt of the chat messages.

Optionally, when the chat messages are displayed in the sliding layout area, opacity of each chat message is set according to a preset rule of opacity, such that the opacity of each chat message varies dynamically. The preset rule of setting opacity can be flexibly configured by those skilled in the art on the basis of their actual experiences. For example, opacity of the chat messages displayed in the sliding layout area may be set to decrease progressively according to the sequential order of receipt of the chat messages, such that the message received earlier fades out and disappears from the screen. Alternatively, opacity of each chat message displayed in the sliding layout area may be set randomly and dynamically, which fulfils the requirement as to entertainment and fun. In short, specific rules as to opacity configuration are not confined by the disclosure.

It follows that, in the method used in a live broadcasting application for displaying a chat message provided by the disclosure, a local region of an interface of the live broadcasting application is pre-set to have a sliding layout area for displaying a chat message, therefore chat messages to be displayed are confined within the said section of the live broadcasting application interface, which effectively prevents chat messages from covering the whole screen.

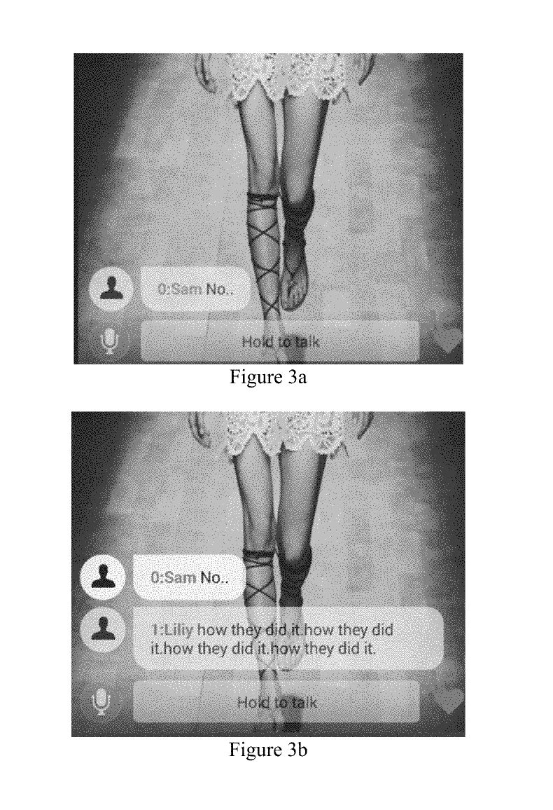

FIG. 2 illustrates a flow chart of a method used in a live broadcasting application for displaying a chat message in accordance with an embodiment of the disclosure. As shown in FIG. 2, the method includes the following steps.

In step S210, a local region of an interface of the live broadcasting application is configured to have a sliding layout for displaying a chat message.

Specifically, in the embodiment, the live broadcasting application interface is vertically divided into an upper section and a lower section, where the lower section is set as the sliding layout area in order chat messages to be concentrated in that area, thereby not interfering with other parts of the live broadcasting application interface. Alternatively, in other embodiments of the disclosure, the live broadcasting application interface may be divided vertically into an upper section, a middle section and a lower section, where one of the divided sections is set as the sliding layout area. Alternatively, the live broadcasting application interface may be horizontally divided into a left section and a right section, and one of the divided sections is set as the sliding layout area. In short, those skilled in the art may flexibly set a location and size of the sliding layout area according to actual needs, such that chat messages will not cover the main part of a live broadcasting picture. For example, the location of a sliding layout area on the screen may be subject to where the main part of the live broadcasting picture is located.

Optionally, the sliding layout area may be set as a movable section. That is, the location of the sliding layout area may be flexibly changed by dragging by a mouse, and in this way, a user may adjust the location of the sliding layout area according to the position where the main part of the live broadcasting picture is located on the screen, whereby the extent of being covered by messages on the screen of the live broadcasting picture is minimized.

In addition, the background of the sliding layout area may be set as needed. In the embodiment, the background of the sliding layout area is set transparent, that is, the opacity is 0. By adopting such approach of setting, the sliding layout area, when no chat message is displayed on the screen, is in a state of completely transparent, thereby bringing about no interference to live broadcasting pictures. In other embodiments of the disclosure, the background of the sliding layout area may be set according to actual cases. For example, in a case that no chat message is displayed in the sliding layout area, the background of the sliding layout area is transparent; and in a case that a chat message is displayed in the sliding layout area, the background of the sliding layout area is colored and translucent.

In step S220, chat messages are received via a message receiving ingress provided by the live broadcasting application.

The message receiving ingress may be implemented by one or more of the following ways: a receiving gateway of word input box kind, a receiving gateway of voice input button kind or a receiving gateway of picture input button kind. When a user watches the live broadcasting picture, the user may transmit a chat message via the message receiving ingress. Content of the chat message generally includes current watching feeling of the user, so as to share and interact with other users.

In step S230, the received chat messages are displayed sequentially in the sliding layout area according to the order in which the messages are received.

The received chat messages include not only chat messages transmitted by a live broadcasting application user of the mobile terminal but also chat messages transmitted by a live broadcasting application user of other terminals. Specifically, live broadcasting application users of other terminals may include all users corresponding to the live broadcasting application, or may include only users having a friend relation with the live broadcasting application user of the mobile terminal. In order to distinguish different users, in displaying the chat messages, not only specific content of the chat message is displayed, but also a sender's identifier information of the chat message is displayed, such as a nickname.

In the embodiment, the chat messages are displayed in the sliding layout area from the bottom up, that is, when a new chat message is received each time, the new chat message is displayed at the bottom of the sliding layout area, such that the previously received chat messages are moved upward correspondingly. In this way, once one message is added, positions of the previous messages are changed correspondingly, such that the messages slide upward and disappear one by one in a case that the messages continuously appear.

In step S230, opacity of the chat messages displayed in the sliding layout area are set according to a preset rule of opacity, such that opacity of the chat messages varies dynamically. The rule of opacity may be flexibly set according to actual need. Several common rules of opacity are shown by reference to the examples below.

### Embodiment 1

In this embodiment, since the background of the sliding layout area is transparent, width and height of the sliding layout area are set as fixed values in advance. For example, the width of the sliding layout area is set as a value slightly less than a width of a live broadcasting picture, and the height of the sliding layout area is set as a value equal to a height corresponding to six rows of chat messages. Hence, in the embodiment, at most six rows of the latest chat messages are displayed in the sliding layout area and the chat messages received earlier are not displayed.

The rule of opacity is: setting opacity of each message according a distance between the message and the top edge of the sliding layout area. Specifically, the opacity of the message is set as a fixed value in a case that the distance between the message and the top edge of the sliding layout area is greater than a preset distance threshold; and the opacity of the message is set to reduce correspondingly with the decreasing of the distance between the message and the top edge of the sliding layout area, in a case that the distance between the message and the top edge of the sliding layout area is less than the preset distance threshold.

In the embodiment, the preset distance threshold is a height value corresponding to three rows of chat messages. Hence, in a case that the number of chat messages displayed in the sliding layout area is less than or equal to three, the opacity of the chat messages each are set as a fixed value such as 0.95, since distances between the three chat messages and the top edge of the sliding layout area are less than the preset distance threshold. In a case that the number of chat messages displayed in the sliding layout area is greater than three, the opacity of three chat messages located in the lower section each are set as a fixed value, and the opacity of the remaining messages are set to reduce correspondingly with the decreasing of the distance between the remaining messages and the top edge of the sliding layout area. For example, in a case that the number of chat messages displayed in the sliding layout area is six, opacity of a first chat message (counting from top to bottom) may be set as 0.3, opacity of a second chat message may be set as 0.6, opacity of a third chat message may be set as 0.9, and opacity of a fourth to a sixth chat messages each are set as 0.95.

### Embodiment 2

In this embodiment, width and height of the sliding layout area are still set as fixed values. For example, the width of the sliding layout area is set as a value slightly less than a width of a live broadcasting picture, and the height of the sliding layout area is set as a value equal to a height corresponding to six rows of chat messages. Hence, in the embodiment, at most six rows of the latest chat messages are displayed in the sliding layout area and the chat messages received earlier are not displayed.

The rule of opacity is: setting opacity of chat messages displayed in the sliding layout area in sequence according to the order of receipt of the chat messages, where opacity of a message which is received later is greater than or equal to opacity of a message which is received earlier. Since the message received later is located below the message received earlier, hence the opacity of the chat messages displayed in the sliding layout area may be set to reduce progressively from bottom to top. For example, from bottom to top, opacity of a first to a third messages are set as 0.95, opacity of a fourth message is set as 0.9, opacity of a fifth message is set as 0.6, and opacity of a sixth message is set as 0.3.

It follows that effects of the second embodiment and the first embodiment are similar, and it does not need to calculate distance between the messages and the top edge of the sliding layout area in the second embodiment, hence the second embodiment is more convenient to be implemented.

### Embodiment 3

In the embodiment, height of the sliding layout area is increased as the number of messages increases. In a case that the number of the messages reaches a preset threshold, the height of the sliding layout area is not increased any more and maintains at the maximum height. In the embodiment, in a case that the number of the messages reaches six, the sliding layout area reaches the maximum height.

Accordingly, in a case that the number of the messages is less than three, height of the sliding layout area is less than the maximum height; hence the height of the sliding layout area is dynamically set according to the height of the messages. In this case, opacity of the messages maintain unchanged, for example, maintaining at a fixed value of 0.95.

In a case that the number of the messages is greater than three but less than six, height of the sliding layout area is less than the maximum height, hence the height of the sliding layout area is dynamically set according to the height of the messages. In this case, opacity of three latest messages (i.e., three messages located at the lowest part) maintain unchanged, opacity of the fourth message (counting from bottom to top) is 0.6, and opacity of a fifth message (counting from bottom to top) is 0.3.

In a case that the number of the messages is not less than six, the height of the sliding layout area is equal to the maximum height, and only six latest messages are displayed. In this case, opacity of the three messages located in the lowest part still maintain unchanged (for example 0.95). Opacity of three messages located in the topmost part is calculated according to the following approach. Three messages located in the topmost part are obtained from the displayed messages in real time; firstly a distance between each message and the top edge of the sliding layout area is calculated; then a ratio of the distance between each message and the top edge of the sliding layout area to the total height of the sliding layout area is calculated; and lastly real-time opacity of the message during a sliding process is obtained according to opacity range preset for each message and the above ratio. For example, opacity range of a message located at the topmost part may be pre-set as 0-0.3, opacity range of a second message may be pre-set as 0.3-0.6, and opacity range of a third message may be pre-set as 0.6-0.9. In this way, opacity of the three messages located in the upper section can be reduced progressively in real time, thereby progressively fading out and disappearing and bringing about good user experiences.

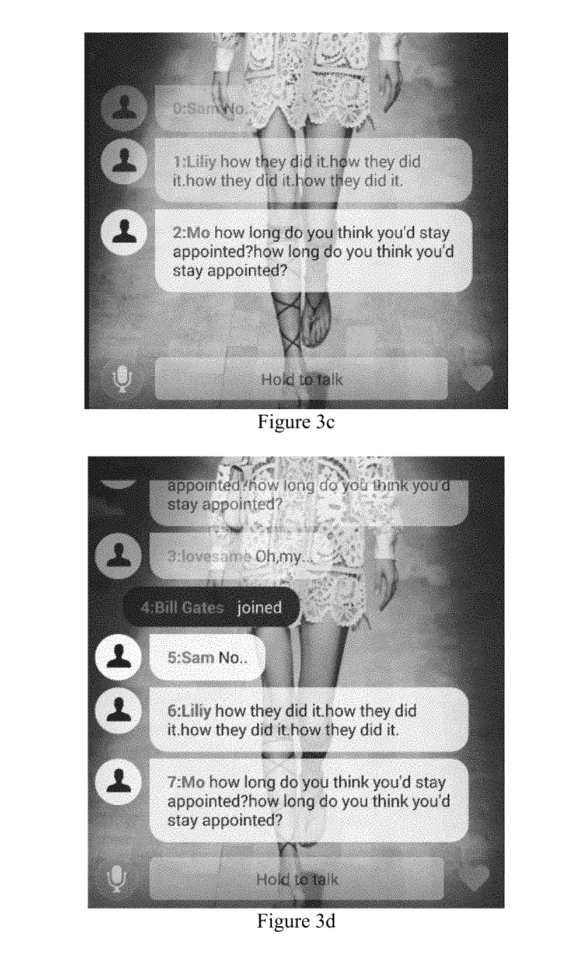

FIG. 3a-FIG. 3d illustrate schematic diagrams of messages displayed in a sliding layout area. FIG. 3a illustrates a schematic diagram in which one message is displayed in the sliding layout area, FIG. 3b illustrates a schematic diagram in which two messages are displayed in the sliding layout area, FIG. 3c illustrates a schematic diagram in which three messages are displayed in the sliding layout area, and FIG. 3d illustrates a schematic diagram in which multiple messages are displayed in the sliding layout area. It can be seen from the figures that, messages located at the upper section are messages received earlier, hence the messages are more transparent.

In addition to the above three embodiments, those skilled in the art may flexibly set other rules of opacity. In addition, part of features in the above three embodiments may be combined with each other, which is not limited by the disclosure.

Optionally, in the method, the received chat messages may be stored sequentially in a message list according to the order of receipt of the chat messages. Accordingly, the method may further include: in a case that a sliding instruction is received by the sliding layout area, obtaining the chat messages stored in the message list and displaying the chat messages sequentially in the sliding layout area according to the order in which the chat messages are received. In a specific implementation, when a user wants to view historical messages, the user only needs to pull down the sliding layout area; the historical messages reappear on the screen in a form of sliding and fading in one by one. The displayed historical messages generally are messages received starting from a time instant when the user enters a live broadcast interface. In addition to pulling down the sliding layout area, many other ways may be used to trigger reappearance of the historical messages, for example, double-clicking the sliding layout area. By this step, the user can view the historical messages using the live broadcasting application. In this way, when messages appear highly concurrently, many classic comments will not disappear for ever with the fading out of the messages, and an audience can cause the faded out messages to reappear, thereby bringing better user experience than the existing live broadcasting application software.

In addition, fading out time for the chat messages may be configured. For example, when no new chat message is received within a preset time interval, the chat messages displayed in the sliding layout area are cleared, such that the user can watch live broadcasting pictures without interference.

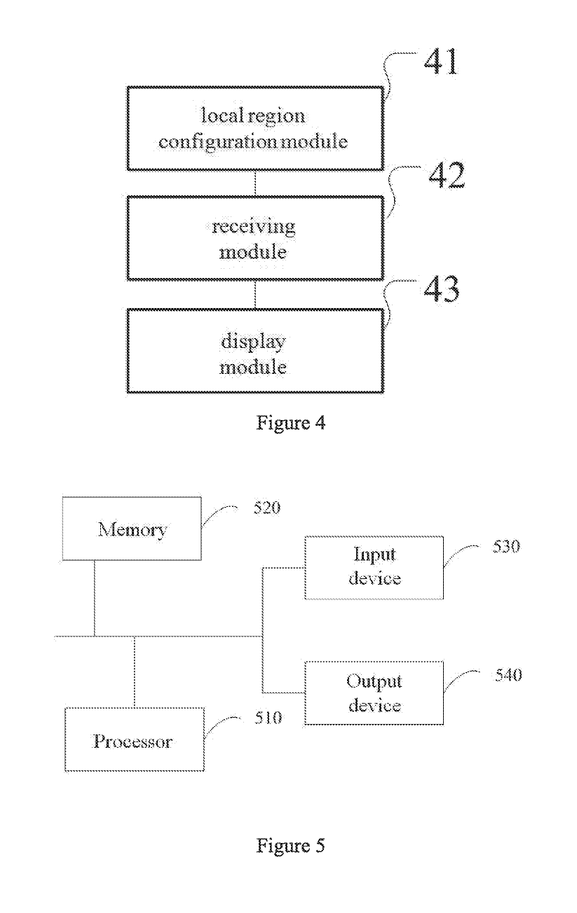

FIG. 4 illustrates a structural diagram of a device for displaying a chat message in a live broadcasting application in accordance with an embodiment of the disclosure. As shown in FIG. 4, the device comprises:

a local region configuration module 41 which is pre-set to set a local region of an interface of the live broadcasting application as a sliding layout area for displaying a chat message;

a receiving module 42 which is configured to receive chat messages via a message receiving ingress provided by the live broadcasting application; and

a display module 43 which is configured to display received chat messages sequentially in the sliding layout area in sequence according to the order of receipt of the chat messages.

When the display module 43 displays the chat messages in the sliding layout area, the display module 43 sets opacity of chat messages according to a preset rule of opacity, such that opacity of the chat messages varies dynamically.

Optionally, when a new chat message is received by the receiving module every time, the display module 43 displays the new chat message at the bottom of the sliding layout area, and causes the previously received chat messages to move upward correspondingly.

Optionally, the rule of opacity is: opacity of each message is set according to the distance between each message and top edge of the said sliding layout area. Opacity of the message is set as a fixed value, in a case that the distance between the message and the top edge of the sliding layout area is greater than a preset distance threshold; and the opacity of the message is set to reduce corresponding with decreasing of the distance between the message and the top edge of the sliding layout area, in a case that the distance between the message and the top edge of the sliding layout area is less than a preset distance threshold. Alternatively, the rule of opacity is: setting opacity of the messages displayed in the sliding layout area in sequence according to the order of receipt of the chat messages, where opacity of a message which is received later is greater than or equal to opacity of a message which is received earlier.

Optionally, the device may further comprise: a message memory module configured to store received chat messages in a message list according to the order of receipt of the chat messages; and in a case that a sliding instruction is received by the sliding layout area, obtain the chat messages stored in the message list and display the chat messages in the sliding layout area in sequence according to the order of receipt of the chat messages.

Optionally, the device may further comprise: a message clearing module configured to clear chat messages displayed in the sliding layout area when no new chat messages is received within a preset time interval.

Optionally, the maximum number of chat messages which can be displayed in the sliding layout area depends on height of the sliding layout area and that opacity of the background of the sliding layout area is 0.

Specific working principles of respective modules described above may be referred to the description of corresponding steps in the embodiments, which are not described in detail here.

In the method and device for displaying chat messages in a live broadcasting application according to the disclosure, in an aspect, a section of the live broadcasting application interface is pre-set as a sliding layout area for displaying chat messages, hence the chat messages are limited to be displayed in the section of the live broadcasting application interface, thereby efficiently preventing the chat messages from occupying the whole screen. In another aspect, when the chat messages are displayed in the sliding layout area, opacity of the chat messages is set according to the preset rule of opacity, such that opacity of the chat messages varies dynamically. It follows that, with the disclosure, not only the chat messages can be efficiently prevented from occupying the whole screen, but also the opacity of the chat messages can vary dynamically, thereby bringing better visual experiences to users.

A non-transitory computer-readable storage medium, wherein the said non-transitory computer-readable storage medium can store computer-executable instructions, and the said computer-executable instructions are configured to execute any one of the said methods, which are used in a live broadcasting application for displaying a chat message, of the present application.

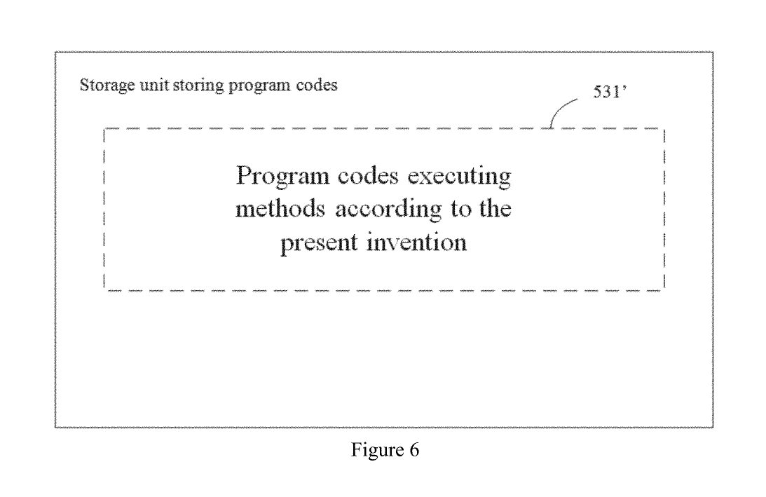

FIG. 5 illustrates the hardware structure of the electronic device executing a method used in a live broadcasting application for displaying a chat message. As shown in FIG. 5, such device comprises: at least one processor 510 which is shown in FIG. 5 as an example, and a memory 520.

The electronic device executing a method used in a live broadcasting application for displaying a chat message further comprises: an input device 530 and an output device 540.

Processor 510, memory 520, input device 530 and output device 540 can be connected by BUS or other methods, and BUS connecting is showed in FIG. 5 as an example.

Memory 520 can be used for storing non-transitory software program, non-transitory computer executable program and modules as a non-transitory computer-readable storage medium, such as corresponding program instructions/modules for the methods for displaying a chat message in a live broadcasting application according to embodiments of the present disclosure (such as shown in FIG. 4, local region configuration module 41, receiving module 42 and display module 43). Processor 510 by executing non-transitory software program performs all kinds of functions of a server and process data, instructions and modules which are stored in memory 520, thereby realizes the methods for displaying a chat message in a live broadcasting application according to the above-mentioned embodiments of the present disclosure.

Memory 520 can include program storage area and data storage area, thereby the operating system and applications required by at least one function can be stored in program storage area and data created by using the device for displaying a chat message in a live broadcasting application can be stored in data storage area. Furthermore, memory 520 can include high speed Random-access memory (RAM) or non-volatile memory such as hard disk storage device, flash memory device or other non-volatile solid state storage devices. In some embodiments, memory 520 can include long-distance setup memories relative to processor 510, which can communicate with the device for displaying a chat message in a live broadcasting application by networks. The examples of said networks are including but not limited to Internet, Intranet, LAN, mobile Internet and their combinations.

Input device 530 can be used to receive inputted number, character information and key signals causing user configures and function controls of the device. Output device 540 can include a display screen or a display device.

The said module or modules are stored in memory 520 and perform any one of the methods for displaying a chat message in a live broadcasting application when executed by one or more processors 510.

The said device can achieve the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smart phones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a hard disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-10. (canceled)

11. A method, applied in a terminal, for displaying a chat message in a live broadcasting application, wherein a local region of an interface of the said live broadcasting application is pre-set to have a sliding layout area for displaying a chat message, comprising:
receiving chat messages via a message receiving ingress provided by the said live broadcasting application; and
displaying each of the received chat messages in the said sliding layout area in sequence according to the order of receipt of the chat messages.

12. The method according to claim 11, further comprising: setting, when displaying chat messages in the said sliding layout area, opacity for each of the chat messages in accordance with a preset rule of opacity, such that opacity of each chat message dynamically varies.

13. The method according to claim 12, wherein the said rule of opacity is that:
opacity of each message is set according to the distance between each message and top edge of the said sliding layout area.

14. The method according to claim 12, wherein the said rule of opacity is that:
opacity of each message displayed in the said sliding layout area is set according to the order of receipt of messages, wherein opacity of a later received message is greater than or equal to the opacity of a earlier received message.

15. The method according to claim 11, further comprising:
storing the received chat messages in a message list according to the order of receipt of the chat messages; and
obtaining, when a sliding instruction is received via the said sliding layout area, each chat message stored in the said message list and displaying each of the chat messages according to the order of receipt of the chat messages in the said sliding layout area.

16. A non-transitory computer-readable storage medium, wherein the said non-transitory computer-readable storage medium store computer-executable instructions that, when executed by an electronic device, cause the electronic device to:
pre-setting a local region of an interface of the said live broadcasting application to have a sliding layout area for displaying a chat message ;
receive chat messages via a message receiving ingress provided by the said live broadcasting application; and
display each of the received chat messages in the said sliding layout area in sequence according to the order of receipt of the chat messages.

17. The non-transitory computer-readable storage medium according to claim 16, wherein the said electronic device to:
set, when displaying each of the chat messages in the said sliding layout area, opacity for each of the chat messages in accordance with a preset rule of opacity, such that opacity of each chat message dynamically varies.

18. The non-transitory computer-readable storage medium according to claim 17, wherein the said rule of opacity is that:
opacity of each message is set according to the distance between each message and top edge of the said sliding layout area.

19. The non-transitory computer-readable storage medium according to claim 17, wherein the said rule of opacity is that:
opacity of each message displayed in the said sliding layout area is set according to the order of receipt of messages, wherein opacity of a later received message is greater than or equal to the opacity of a earlier received message.

20. The non-transitory computer-readable storage medium according to claim 16, wherein the said electronic device to:
store the received chat messages in a message list according to the order of receipt of the chat messages; and
obtain, when a sliding instruction is received via the said sliding layout area, each chat message stored in the said message list and displaying each of the chat messages according to the sequential order of receipt of the chat messages in the said sliding layout area.

21. An electronic device, comprising:
at least one processor; and
a memory communicably connected with the said at least one processor; wherein,
the said memory stores instructions executable by the said at least one processor, wherein execution of the instructions by the said at least one processor causes the at least one processor to:
pre-setting a local region of an interface of the said live broadcasting application to have a sliding layout area for displaying a chat message ;
receive chat messages via a message receiving ingress provided by the said live broadcasting application; and
display each of the received chat messages in the said sliding layout area in sequence according to the order of receipt of the chat messages.

22. The electronic device according to claim 21, wherein the said at least one processor is further caused to:
setting, when displaying each of the chat messages in the said sliding layout area, opacity for each of the chat messages in accordance with a preset rule of opacity, such that opacity of each chat message dynamically varies.

23. The electronic device according to claim 22, wherein the said rule of opacity is that:
opacity of each message is set according to the distance between each message and top edge of the said sliding layout area.

24. The electronic device according to claim 22, wherein the said rule of opacity is that:
opacity of each message displayed in the said sliding layout area is set according to the order of receipt of messages, wherein opacity of a later received message is greater than or equal to the opacity of a earlier received message.

25. The electronic device according to claim 21, wherein the said at least one processor further executes the following steps::
store the received chat messages in a message list according to the order of receipt of the chat messages, and obtain, when a sliding instruction is received via the said sliding layout area, each chat message stored in the said message list and display the each of chat messages according to the sequential order of receipt of the chat messages in the said sliding layout area.
